(19) United States
(12) Patent Application Publication
(10) Pub. No.: US 2024/0183431 A1
(43) Pub. Date: Jun. 6, 2024

(54) POWER TRANSMISSION DEVICE

(71) Applicant: Dong-Hoon PARK, Seongnam-si (KR)

(72) Inventor: Dong-Hoon PARK, Seongnam-si (KR)

(21) Appl. No.: 18/519,279

(22) Filed: Nov. 27, 2023

(30) Foreign Application Priority Data
Nov. 28, 2022 (KR) 10-2022-0161265
Nov. 27, 2023 (KR) 10-2023-0166275

(51) Int. Cl. F16H 3/72; F16H 3/76; F16H 57/02

(52) U.S. Cl. CPC F16H 3/727; F16H 3/76; F16H 2057/02017; F16H 2057/02043

(57) ABSTRACT

Disclosed is a power transmission device.

The power transmission device includes: a drive motor assembly including a motor housing, a first motor disposed in a front portion of the motor housing and rotating a first pinion gear in a first rotation direction, and a second motor disposed in a rear portion of the motor housing and rotating a second pinion gear in a second rotation direction opposite to the first rotation direction; a drum surrounding the drive motor assembly by including a drum disk portion disposed on one surface in a wheel axis direction and a cylindrical portion extending from an outer diameter end of the drum disk portion in the wheel axis direction; a drum cover coupled to the other surface of the drum in the wheel axis direction, and having a ring gear disposed on its outer diameter and meshed with the first and second pinion gears; and a wheel hub installed with a tire, and coupled to the drum to be rotated together with the drum, wherein the first and second motors are disposed to be parallel to a horizontal line horizontal to the ground passing through a center of a wheel.

### CROSS-REFERENCE TO RELATED APPLICATION

This application claims priority to and the benefit of Korean Patent Application No. 10-2023-0166275 filed in the Korean Intellectual Property Office on Nov. 27, 2023, and Korean Patent Application No. 10-2022-0161265 filed in the Korean Intellectual Property Office on Nov. 28, 2022, the entire contents of which are incorporated herein by reference.

### BACKGROUND OF THE INVENTION

### (a) Field of the Invention

The disclosure relates to a power transmission device, and more particularly, to a power transmission device which may be used in a wheel drive unit or the like.

### (b) Description of the Related Art

In recent years, the use of an eco-friendly vehicle such as a hybrid vehicle and an electric vehicle is increasing due to tightened environmental regulation and fuel economy regulation. The eco-friendly vehicle may include an electric motor as a power source, and various types of eco-friendly vehicles may be implemented based on dispositions of the electric motor and a reducer.

One of the various disposition methods of the power source for the eco-friendly vehicles may be a method of using a wheel drive unit in which the power source is disposed in or near a wheel hub. A conventional wheel drive unit may have a large size, and a portion of the wheel drive unit may protrude outside the wheel hub. Such a portion of the wheel drive unit that protrudes to the outside the wheel hub may cause interference with a vehicle part such as a suspension or a braking device. Accordingly, a design change in a vehicle body or a chassis may be required to install the conventional wheel drive unit on the vehicle.

An in-wheel motor system has been developed to solve this problem. The in-wheel motor system may be a system in which the electric motor, which is the power source, and the reducer are disposed in the wheel hub. A conventional in-wheel motor system may mainly use a planetary gear set as its reducer. However, it is difficult to dispose the electric motor, the planetary gear set, and a wheel bearing in the wheel hub. Accordingly, an in-wheel motor system including no reducer has been developed.

However, the in-wheel motor system including no reducer may require a large-capacity electric motor because the vehicle is required to be launched and driven at a high speed by power of the electric motor itself. As a result, the in-wheel motor system may consume a lot of power, thus causing a limit to a distance in which the vehicle may be driven on a single charge. The system is required to use a large-capacity battery to compensate for this problem.

Meanwhile, according to conventional technology, one pinion gear included in a reduction device may rotate a ring gear, stress may be concentrated on one pinion gear, thus lowering durability of the reduction device. In addition, a road impact occurring while the vehicle is driven may be also transmitted directly to one pinion gear through the ring gear, thus further lowering the durability of the reduction device.

The above information disclosed in this Background section is provided only to assist in more understanding of the background of the disclosure, and may thus include information not included in the prior art already known to those skilled in the art to which the disclosure pertains.

### SUMMARY OF THE INVENTION

The disclosure attempts to provide a power transmission device which may reduce stress acting on each of two pinion gears and improve durability of a reduction device by rotating two motors in opposite directions to each other through one stator coil winding and driving a ring gear through the two pinion gears.

In addition, the disclosure attempts to provide a power transmission device in which a road impact is distributed and transmitted to two pinion gears rotated in opposite directions through a ring gear.

According to an aspect, a power transmission device includes: a drive motor assembly including a motor housing, a first motor disposed in a front portion of the motor housing and rotating a first pinion gear in a first rotation direction, and a second motor disposed in a rear portion of the motor housing and rotating a second pinion gear in a second rotation direction opposite to the first rotation direction; a drum surrounding the drive motor assembly by including a drum disk portion disposed on one surface in a wheel axis direction and a cylindrical portion extending from an outer diameter end of the drum disk portion in the wheel axis direction; a drum cover coupled to the other surface of the drum in the wheel axis direction, and having a ring gear disposed on its outer diameter and meshed with the first and second pinion gears; and a wheel hub installed with a tire, and coupled to the drum to be rotated together with the drum, wherein the first and second motors are disposed to be parallel to a horizontal line horizontal to the ground passing through a center of a wheel.

In an embodiment, the first and second motors may be disposed on the horizontal line.

In another embodiment, the first and second motors may be disposed to be spaced apart from the horizontal line by a first separation distance.

The first and second pinion gears may be rotated at the same speed.

The motor housing may further include a center support protruding radially inward from a middle portion of the motor housing, and the first motor may be disposed at the front of the center support, and the second motor may be disposed at the rear of the center support.

The first motor may include: a first stator fixed to the front portion of the motor housing and generating a magnetic field; a first rotor disposed inside the first stator in a radial direction while having a predetermined gap with the first stator, and rotated in the first rotation direction by the magnetic field generated by the first stator; and a first motor shaft coupled to the first rotor to be rotated together with the first rotor, and extending to the front and the rear in a length direction, and the first pinion gear may be disposed at a front end of the first motor shaft that protrudes forward from the motor housing.

The second motor may include: a second stator fixed to the rear portion of the motor housing and generating the magnetic field; a second rotor disposed inside the second stator in the radial direction while having a predetermined gap with the second stator and rotated in the second rotation direction by the magnetic field generated by the second stator; and a second motor shaft coupled to the second rotor to be rotated together with the second rotor, including a motor shaft hole formed in a front center in the length direction, and extending to the rear in the length direction, the second pinion gear may be disposed at a rear end of the second motor shaft that protrudes rearward from the motor housing, and a rear end of the first motor shaft that extends rearward in the length direction may be inserted into the motor shaft hole.

The first stator may be provided by winding a stator coil around a first stator core, the second stator may be provided by winding the stator coil around a second stator core, and the stator coil may be wound around the first and second stator cores in an “8” shape for a current around the first stator core and a current around the second stator core to be circulated in opposite directions.

The disclosure may reduce the stress acting on each pinion gear by rotating the two motors in the opposite directions through the winding of one stator coil and driving the ring gear through the two pinion gears. It is thus possible to improve the durability of the reduction device.

It is also possible to distribute and transmit the road impact to the two pinion gears rotated in the opposite directions through the ring gear. A shock of the road impact may be distributed and transmitted, thus further improving the durability of the reduction device. In addition, the stress acting on each driving and/or driven pinion gear may be halved, thus making the pinion gears smaller.

Other effects which may be acquired or predicted by the embodiments of the disclosure are disclosed directly or implicitly in the detailed description of the embodiments of the disclosure. That is, various effects predicted based on the embodiments of the disclosure are disclosed in the detailed description described below.

### BRIEF DESCRIPTION OF THE DRAWINGS

Embodiments in the specification may be better understood by referring to the following description in connection with the accompanying drawings in which similar reference numerals refer to identical or functionally similar elements.

FIG. 1 is a front view of a power transmission device according to an embodiment of the disclosure.

FIG. 2 is a side view of the power transmission device according to an embodiment of the disclosure.

FIG. 3 is a cross-sectional view taken along a line A-A of FIG. 1.

FIG. 4 is a cross-sectional view taken along a line B-B of FIG. 2.

FIG. 5 schematically shows winding of a stator coil according to an embodiment of the disclosure.

FIG. 6 is a cross-sectional view taken along the line B-B of FIG. 2 in a power transmission device according to another embodiment of the disclosure.

It should be understood that the drawings referenced above are not necessarily drawn to scale, and present a rather simplified representation of various preferred features showing the basic principles of the disclosure. For example, specific design features of the disclosure, including its specific dimension, orientation, position, and shape, are determined in part by the particular intended application and environment of use.

### DETAILED DESCRIPTION OF THE EMBODIMENTS

Terms in the specification are used to describe specific embodiments, and are not intended to limit the disclosure. Terms of a singular number used in the specification are intended to include its plural number unless the context clearly indicates otherwise. It is to be understood that terms “comprise,” or “include” used in the specification specify the presence of features, numerals, steps, operations, elements and/or components, and do not preclude the presence or addition of one or more other features, numerals, steps, operations, components and/or groups thereof. The term “and/or” used herein includes any one or all combinations of one or more associated listed items. A term “coupled” used herein indicates a physical relationship between two components directly connected to each other, or indirectly connected to each other through one or more medium components.

A “coupling means” or a similar term may indicate a means for coupling at least two members to be rotated together. An example of the coupling means may be a bolt, a nut, welding, press-fitting, an adhesive, a spline, or the like, and is not limited thereto.

An expression “operably connected” or a similar expression may indicate that at least two members are directly or indirectly connected to each other to thus transmit power. However, two members operably connected to each other may not be always rotated at the same speed and in the same direction.

It should be understood that a term used herein such as “a vehicle,” “of a vehicle” or another similar term generally refers to a passenger vehicle including a sports utility vehicle (SUV), a bus, a truck, any of various commercial vehicles, a vessel including any of various boats and ships, a truck, an aircraft, or the like, and also refers to a hybrid electric vehicle, an electric vehicle, a plug-in hybrid electric vehicle, a hydrogen powered vehicle, or a vehicle using another alternative fuel (e.g., fuel acquired from a resource other than petroleum). As referenced herein, the electric vehicle (EV) is a vehicle having electric power acquired from a rechargeable energy storage device (e.g., one or more rechargeable electrochemical cells or another type of battery) as a part of its driving force. The electric vehicle (EV) is not limited to an automobile, and may include a motorcycle, a cart, a scooter, or the like. In addition, a hybrid vehicle is a vehicle (e.g., hybrid electric vehicle (HEV)) having two or more power sources, e.g., gasoline-based power and electricity-based power.

Further, it is to be understood that one or more of methods described below or aspects thereof may be executed by at least one or more controllers. The term “controller” may refer to a hardware device including a memory and a processor. The memory may store program instructions, and the processor may be specifically programmed to execute the program instructions to perform one or more processes described below in more detail. The controller may control operations of units, modules, parts, devices, or the like, as described herein. It is also to be understood that the methods described below may be executed by a device including the controller in conjunction with one or more other components, as appreciated by those skilled in the art.

Hereinafter, the disclosure is described in detail with reference to the accompanying drawings.

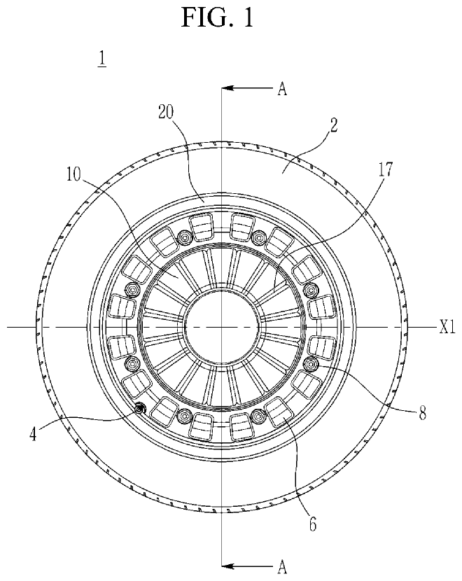

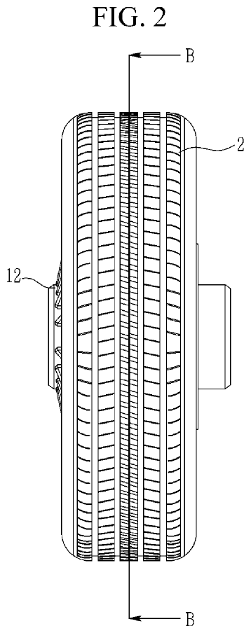

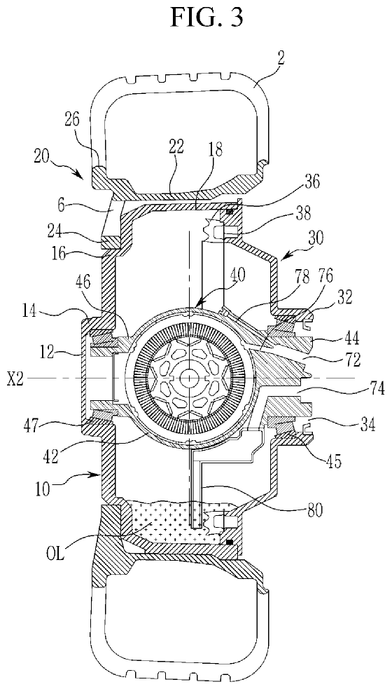

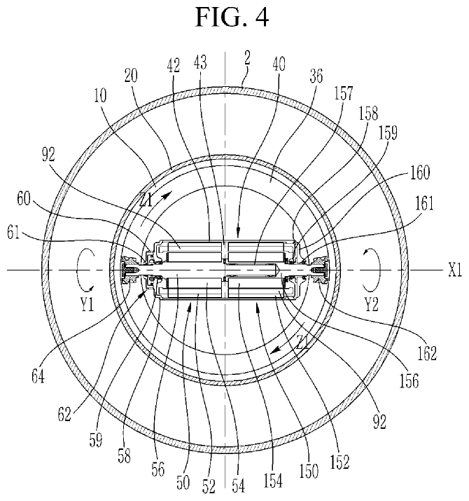

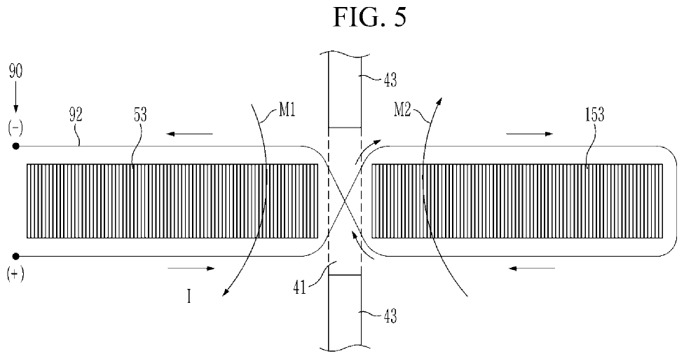

FIG. 1 is a front view of a power transmission device according to an embodiment of the disclosure; FIG. 2 is a side view of the power transmission device according to an embodiment of the disclosure; FIG. 3 is a cross-sectional view taken along a line A-A of FIG. 1; FIG. 4 is a cross-sectional view taken along a line B-B of FIG. 2; and FIG. 5 schematically shows winding of a stator coil according to an embodiment of the disclosure.

As shown in FIGS. 1 to 4, a power transmission device 1 according to an embodiment of the disclosure may be installed in a wheel and function as a wheel drive unit. The power transmission device 1 may include a drum 10, a drum cover 30, a wheel hub 20, and a drive motor assembly 40.

The drum 10 may have a space for installing the drive motor assembly 40, and have a substantially cylindrical shape surrounding the drive motor assembly 40. The drum 10 may include a drum disk portion 12 and a drum cylindrical portion 18.

The drum disk portion 12 may have a substantial disk shape, may be disposed on one surface of the drum 10 in a wheel axis direction X2, and may include first and second step portions 14 and 16. The first step portion 14 may be disposed radially inside the drum 10 than the second step portion 16. That is, the drum disk portion 12 may extend outward from a wheel axis in a radial direction, extend from the first step portion 14 to the other side in the wheel axis direction X2, extend outward again in the radial direction, extend again from the second step portion 16 to the other side in the wheel axis direction X2, and extend outward again in the radial direction. The first step portion 14 may face a bearing support 46 in the radial direction. A bearing 47 may be disposed between the first step portion 14 and the bearing support 46, and the drum 10 may be disposed to be rotatable with respect to the drive motor assembly 40. The drum disk portion 12 may be formed integrally or provided separately with coupling means such as a bolt 8 for its coupling with the wheel hub 20. As shown in FIG. 1, the drum disk portion 12 may have at least one drum rib 17, which extends in the radial direction, between the first step portion 14 and the second step portion 16. The drum rib 17 may not only reinforce rigidity of the drum 10, but also serve as a fin for dissipating heat occurring in the drum 10 to the outside of the drum 10.

The drum cylindrical portion 18 may extend from an outer diameter end of the drum disk portion 12 to the other side in the wheel axis direction X2. Accordingly, the drum 10 may have a space for installing the drive motor assembly 40 therein. The wheel hub 20 may be disposed on an outer peripheral surface of the drum cylindrical portion 18, and the drum cylindrical portion 18 may thus support the wheel hub 20. As shown in FIG. 3, predetermined positions on the outer peripheral surface of the drum cylindrical portion 18 in a circumferential direction may each be spaced apart from an inner peripheral surface of the wheel hub 20, thus providing an air passage formed therebetween and extending in the wheel axis direction X2. The air passage may be communicated with an air inlet 6 of the wheel hub 20, and accordingly, air introduced between the wheel hub 20 and the drum 10 through the air inlet 6 of the wheel hub 20 may pass through the air passage and cool oil in the drum 10.

As shown in FIG. 3, the other surface of the drum 10 in the wheel axis direction may be open, and the drum cover 30 may be coupled to the other surface of the drum 10. The drum cover 30 may have a substantial disk shape, and a drum cover hole 34 may be formed in its center. The outer diameter end of the drum cover 30 may be in contact with the other end of the drum cylindrical portion 18 of the drum 10, and coupled thereto through the coupling means such as the bolt. A sealing member may be disposed between the outer diameter end of the drum cover 30 and the other end of the drum cylindrical portion 18 of the drum 10 to prevent oil in the drum 10 from leaking out of the drum 10.

The drum cover 30 may include a drum cover seat 32. The drum cover seat 32 may extend from a radial inner end of the drum cover 30 to the other side in the wheel axis direction X2 to form the drum cover hole 34. The drum cover hole 34 may be provided for connecting the drive motor assembly 40 to a vehicle body (or chassis) or a suspension. In more detail, a motor arm 44 of the drive motor assembly 40 may protrude outward from the wheel hub 20 through the drum cover hole 34 to be fixed to the vehicle body (or chassis) or the suspension. A bearing 45 may be disposed between an inner peripheral surface of the drum cover hole 34 and the motor arm 44, and the drum cover 30 may thus be rotated with respect to the drive motor assembly 40.

A ring gear 36 may be disposed on one surface of an outer diameter of the drum cover 30. The ring gear 36 may be manufactured separately from the drum cover 30 and coupled to the drum cover 30 through the coupling means such as the bolt and/or the spline, or may be formed integrally with the drum cover 30. When the ring gear 36 is manufactured separately from the drum cover 30 and coupled to the drum cover 30 through the coupling means, a spacer 38 may be disposed between the drum cover 30 and the ring gear 36. The spacer 38 may adjust a backlash or the like between first and second pinion gears 64 and 162 and the ring gear 36. In one example, the ring gear 36 may be the ring gear of a spiral bevel gear.

The ring gear 36 may be meshed with the first and second pinion gears 64 and 162 in the wheel axis direction X2. Accordingly, the drum cover 30 may receive power from the drive motor assembly 40 to be rotated around the wheel axis, and the drum 10 coupled to the drum cover 30 may also be rotated around the wheel axis by this power. In addition, the bearing 47 may be disposed between the first step portion 14 of the drum 10 and the bearing support 46 of a motor housing 42, the bearing 45 may be disposed between the inner peripheral surface of the drum cover hole 34 and the motor arm 44 of the motor housing 42. Therefore, the motor housing 42 may be fixed to the chassis, the vehicle body, or the suspension, while the drum 10 and the drum cover 30 may be smoothly rotated.

The number of gear teeth of the ring gear 36 may be greater than the number of gear teeth of each of the first and second pinion gears 64 and 162. Therefore, the vehicle may have a reduced rotation speed in a process of transmitting power from the drive motor assembly 40 to the drum cover 30. That is, according to an embodiment of the disclosure, the vehicle may acquire a reduction gear ratio required for its launch or high-speed driving through the first and second pinion gears 64 and 162 and the ring gear 36, which are meshed with each other. Therefore, the small and lightweight power transmission device 1 may be implemented using the reduction device with a simple structure.

Each of the first and second pinion gears 64 and 162, or the ring gear 36 may be a bevel gear, the spiral bevel gear, or the like. In this way, the power transmission device 1 according to an embodiment of the disclosure may acquire the necessary reduction gear ratio with only the two pinion gears 64 and 162 and one ring gear 36, thus achieving higher power transmission efficiency compared to a wheel drive system using a planetary gear and a multi-stage reducer. In addition, power of the drive motor assembly 40 may be transmitted to the ring gear 36 through the two pinion gears 64 and 162, thereby reducing stress acting on each of the two pinion gears 64 and 162. Further, the road impact may also be distributed and transmitted to the two pinion gears 64 and 162 through the ring gear 36. Accordingly, each of the two pinion gears 64 and 162 and the ring gear 36 may have improved durability.

The wheel hub 20 may be operably connected to the drum 10 to receive power from the drum 10. The wheel hub 20 may be rotated about the wheel axis to finally output power. The wheel hub 20 may have a substantially cylindrical shape, and include a shoulder part 22, a coupling part 24, and a tire installation part 26. The shoulder part 22, the coupling part 24, and the tire installation part 26 may be formed integrally with each other.

The shoulder part 22 may extend in the wheel axis direction X2 to form a space where the power transmission device 1 may be disposed. The shoulder part 22 may define an axial width of the wheel hub 20, and at least the drive motor assembly 40, the drum 10, and the drum cover 30 may be mostly disposed in the axial width defined by the shoulder part 22. Accordingly, it is possible to minimize parts disposed outside the axial width of the wheel hub 20, thereby minimizing interference between the power transmission device 1 and the vehicle part. Therefore, the power transmission device 1 may be very easily installed on the vehicle chassis or the vehicle body. A predetermined position of the shoulder part 22 may be spaced apart from the drum cylindrical portion 18 in the circumferential direction, while another position of the shoulder part 22 may be pressed into the drum cylindrical portion 18 of the drum 10.

The coupling part 24 may extend radially inward from one end of the shoulder part 22, and may be pressed into the drum disk portion 12 of the drum 10 or coupled thereto through the coupling means such as the bolt 8. As shown in FIGS. 1 and 3, the plurality of air inlets 6 may be formed at the coupling part 24 in the circumferential direction, and the air inlet 6 may be communicated with the air passage. Therefore, air introduced between the wheel hub 20 and the drum 10 through the air inlet 6 may cool the oil in drum 10 while passing through the air passage.

The tire installation part 26 may protrude outward in the radial direction from each of two ends of the shoulder part 22 in the wheel axis direction X2. A tire 2 may be installed on tire installation part 26. The tire 2 may be a rubber tire, a urethane wheel, or the like.

An air injection device 4 may be installed at the wheel hub 10 to inject air into the tire 2.

As shown in FIGS. 3 and 4, the drive motor assembly 40 may be connected to a power source 90 (see FIG. 5) such as a battery to generate power to drive the vehicle, and may include the motor housing 42, a first motor 50, and a second motor 150. Here, the first and second motors 50 and 150 may be disposed in one motor housing 42 and each motor may be an electric motor.

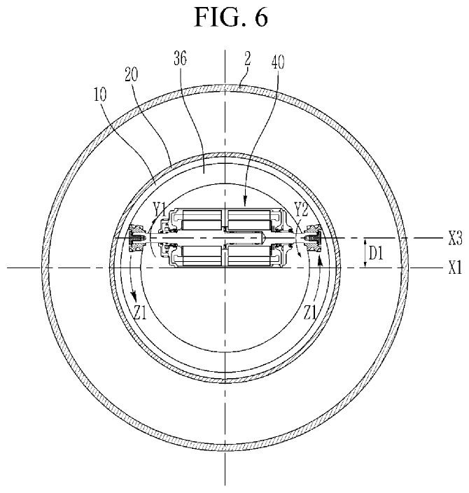

The motor housing 42 may have a through cylindrical shape with an open front surface, a side surface, and an open rear surface, and form an installation space for installing the first and second motors 50 and 150 in such a manner that a front cover 58 is coupled to the open front surface through the coupling means such as the bolt, and a rear cover 158 is coupled to the open rear surface through the coupling means such as the bolt. In addition, a center support 43 may protrude radially inward from a middle portion of the motor housing 42, thus dividing the installation space into the installation space for the first motor 50 and the install space for the second motor 150. In one example, the drive motor assembly 40 may be disposed horizontally. That is, a center line X3 of the first and second motors 50 and 150 that extends in a length direction may be disposed to coincide with or be parallel to a horizontal line X1 horizontal to the ground passing through the center of the wheel (see FIGS. 4 and 6). A front cover hole 59 may be formed in the front cover 58, and a rear cover hole 159 may be formed in the rear cover 158.

As shown in FIGS. 3 and 4, the motor housing 42 may include the motor arm 44 and the bearing support 46 each extending from the side surfaces of the motor housing 42 in the wheel axis direction X2. The bearing support 46 may extend from the side surface to one side in the wheel axis direction X2, and the motor arm 44 may extend from the side surface opposite to the bearing support 46 to the other side in the wheel axis direction X2.

The motor arm 44 may have one end integrally formed with the motor housing 42, and the other end extending to the other side in the wheel axis direction X2 to extend out of the wheel hub 20 through the drum cover hole 34. The other end of the motor arm 44 may be fixed to the vehicle body (or chassis) or the suspension, for example, a knuckle, through a flange or the like.

The drive motor assembly 40 may be fixed to the suspension or the vehicle body such as the knuckle through the motor arm 44. In this case, the road impact occurring when the vehicle is driven, or a wheel impact occurring in sudden acceleration or sudden braking may not be directly transmitted to the part in the motor housing 42, such as the first and second motors 50 and 150, thereby improving the durability of each of the drive motor assembly 40 and the related parts. In addition, the bearing 45 may be disposed between the inner peripheral surface of the drum cover hole 34 and the motor arm 44 to enable the drum cover 30 to be smoothly rotated with respect to the motor arm 44.

The bearing support 46 may have the other end formed integrally with the motor housing 42, and one end extending to one side in the wheel axis direction X2 and extending to the drum disk portion 12. The bearing 47 may be disposed between the first step portion 14 and the bearing support 46 to enable the drum 10 to be smoothly rotated with respect to the bearing support 46.

In addition, when the bearing support 46 and the motor arm 44 are formed on the two sides of the motor housing 42 in the wheel axis direction X2, the bearing support 46 and the motor arm 44 may support the two sides of the drive motor assembly 40 to prevent the road impact or the like from being directly transmitted to the drive motor assembly 40, thereby further improving the durability of the drive motor assembly 40.

As shown in FIGS. 3 to 5, the first motor 50 may be disposed in a front portion of the motor housing 42 in the length direction. That is, the first motor 50 may be disposed between the center support 43 and the front cover 58. The first motor 50 may include a first stator 52, a first rotor 54, and a first motor shaft 56.

The first stator 52 may be disposed in the motor housing 42 and fixed to the motor housing 42. The first stator 52 may be connected to the power source 90 to thus form a magnetic field, and include a first stator core 53 and a stator coil 92 surrounding the first stator core 53 (see FIG. 5). A structure of the first stator 52 is well known to those skilled in the art, and the description thus omits any further detailed description thereof.

The first rotor 54 may be disposed inside the first stator 52 in the radial direction while having a predetermined gap with the first stator 52. The first rotor 54 may be rotated by the magnetic field generated by the first stator 52. In one example, a permanent magnet may be attached to or embedded in an outer diameter of the first rotor 54. The first motor 50 including the first rotor 54 may be referred to as a permanent magnet synchronous motor (PMSM). However, it is to be understood that the specification only exemplifies one type of the first motor 50, and that the disclosure is not limited to the type of first motor 50 exemplified in the specification.

The first motor shaft 56 may extend in the length direction to pass through the front cover hole 59, and a first pinion gear 64 may be fixedly disposed at a front end of the first motor shaft 56 that passes through the front cover hole 59. The bearing and the sealing member may be disposed between the front cover hole 59 and the first motor shaft 56. The bearing may assist a smooth rotation of the first motor shaft 56, and the sealing member may prevent oil in the motor housing 42 from leaking out of the motor housing 42. In addition, the bearing may be disposed between the center support 43 and the first motor shaft 56 to assist the smooth rotation of the first motor shaft 56.

The first motor shaft 56 may penetrate through the center of the first rotor 54, and extend to the front and the rear along the center line X3 of the first motor. The first motor shaft 56 may be coupled to the first rotor 54 to be rotated together with the first rotor 54. In one example, the first rotor 54 may be coupled to the first motor shaft 56 by the spline or a key.

As shown in FIGS. 3 and 4, the second motor 150 may be disposed in a rear portion of the motor housing 42 in the length direction. That is, the second motor 150 may be disposed between the center support 43 and the rear cover 158. The second motor 150 may include a second stator 152, a second rotor 154, and a second motor shaft 156.

The second stator 152 may be disposed in the motor housing 42 and fixed to the motor housing 42. The second stator 152 may be connected to the power source 90 to thus form the magnetic field, and include a second stator core 153 and the stator coil 92 surrounding the second stator core 153 (see FIG. 5). A structure of the second stator 152 is well known to those skilled in the art, and the description thus omits any further detailed description thereof.

The second rotor 154 may be disposed inside the second stator 152 in the radial direction while having a predetermined gap with the second stator 152. The second rotor 154 may be rotated by the magnetic field generated by the second stator 152. In one example, a permanent magnet may be attached to or embedded in an outer diameter of the second rotor 154. The second motor 150 including the second rotor 154 may be referred to as the permanent magnet synchronous motor (PMSM). However, it is to be understood that the specification only exemplifies one type of the second motor 150, and that the disclosure is not limited to the type of second motor 150 exemplified in the specification.

The second motor shaft 156 may extend in the length direction to pass through the rear cover hole 159, and a second pinion gear 162 may be fixedly disposed at a rear end of the second motor shaft 156 that passes through the rear cover hole 159. The bearing and the sealing member may be disposed between the rear cover hole 159 and the second motor shaft 156. The bearing may assist a smooth rotation of the second motor shaft 156, and the sealing member may prevent oil in the motor housing 42 from leaking out of the motor housing 42. In addition, the bearing may be disposed between the center support 43 and the second motor shaft 156 to assist the smooth rotation of the second motor shaft 156.

The second motor shaft 156 may penetrate through the center of the second rotor 154 and extend to the rear along the center line X3 of the second motor. The second motor shaft 156 may be coupled to the second rotor 154 to be rotated together with the second rotor 154. In one example, the second rotor 154 may be coupled to the second motor shaft 156 by the spline or the key.

A motor shaft hole 157 may be formed rearward in a front center of the second motor shaft 156, and the rear portion of the first motor shaft 56 that extends in the length direction may be inserted into the motor shaft hole 157. The bearing may be disposed between the rear portion of the first motor shaft 56 and the motor shaft hole 157 to enable relative rotations of the first and second motor shafts 56 and 156 and to rotation center lines of the first and second motor shafts 56 and 156 to be aligned with each other. In addition, a motor shaft support cover 160 may be disposed on the rear surface of the rear cover 158. The motor shaft support cover 160 may be formed integrally with the rear cover 158, or may be manufactured separately from the rear cover 158 and installed at the rear cover 158. The second motor shaft 156 may extend rearward by penetrating through the motor shaft support cover hole 161 formed in the center of the motor shaft support cover 160, and the second pinion gear 162 may be fixedly disposed on the second motor shaft 156 at the rear of the motor shaft support cover 160. The bearing may be disposed between the motor shaft support cover hole 161 and the second motor shaft 156 to assist the smooth rotation of the second motor shaft 156 and the alignment of the rotation center lines of the first and second motor shafts 56 and 156.

The drive motor assembly 40 may be provided with a resolver 62 measuring a rotation speed of the first motor shaft 56 by generating a change in a physical value (e.g., a change in a magnetic pole or the magnetic field) corresponding to the rotation speed of the first motor shaft 56. The resolver 62 may include a resolver rotor attached to the first motor shaft 56 and a resolver stator installed on the front cover 58.

A resolver cover 60 may be further installed on a front surface of the front cover 58 to protect the resolver stator. The resolver cover 60 may surround the resolver 62, and may be fixed to the front cover 58 through the coupling means such as the bolt.

A resolver cover hole 61 may be formed in a front center of the resolver cover 60, and the front end of the first motor shaft 56 may pass through the resolver cover hole 61 and extend to the front of the resolver cover hole 61. An inner peripheral surface of the resolver cover hole 61 and an outer peripheral surface of the first motor shaft 56 may be spaced apart from each other, and the sealing member may be disposed therebetween to prevent oil from penetrating into a space formed by the resolver cover 60 and the first motor shaft 56.

As described above, the front end of the first motor shaft 56 may pass through the front cover hole 59 of the front cover 58 to protrude outward from the front cover 58, and the first pinion gear 64 meshed with the ring gear 36 may be disposed at the front end of the first motor shaft 56 that protrudes outward from the front cover 58. The first pinion gear 64 may be manufactured separately from the first motor shaft 56 to be coupled to the front end of the first motor shaft 56 through the coupling means such as the fixing bolt and/or the spline, or may be formed integrally with the first motor shaft 56. In one example, the first pinion gear 64 may be formed as the pinion gear of the spiral bevel gear. The rear end of the second motor shaft 156 may pass through the rear cover hole 159 of the rear cover 158 to protrude outward from the rear cover 158, and the second pinion gear 162 meshed with the ring gear 36 may be disposed at the rear end of the second motor shaft 156 that protrudes outward from the rear cover 158. The second pinion gear 162 may be manufactured separately from the second motor shaft 156 to be coupled to the rear end of the second motor shaft 156 through the coupling means such as the fixing bolt and/or the spline, or may be formed integrally with the second motor shaft 156. In one example, the second pinion gear 162 may be formed as the pinion gear of the spiral bevel gear.

In this way, power of the drive motor assembly 40 may be transmitted to the ring gear 36 through the two pinion gears 64 and 162, thereby reducing the stress acting on each of the two pinion gears 64 and 162. Further, the road impact may also be distributed and transmitted to the two pinion gears 64 and 162 through the ring gear 36. Accordingly, each of the two pinion gears 64 and 162 and the ring gear 36 may have the improved durability.

In an embodiment of the disclosure, when the ring gear 36 is rotated, the first pinion gear 64 and the second pinion gear 162 are required to be rotated at the same speed in opposite directions. To the end, the stator coil 92 may ensure that a first magnetic flux direction M1 generated in the first stator 52 and a second magnetic flux direction M2 generated in the second stator 152 are opposite to each other. The description describes winding of the stator coil 92 in more detail with reference to FIG. 5.

As shown in FIG. 5, the stator coil 92 may be connected to the power source 90, and wound around the first and second stator cores 53 and 153 in an “8” shape for a current around first stator core 53 and a current around the second stator core 153 to be circulated in opposite directions. To describe in more detail, in one example, the first and second stator cores 53 and 153 may be disposed to be spaced apart from each other, and the stator coil 92 may start from a positive (+) terminal of the power source 90 and extend to the second stator core 153 along one side of the first stator core 53, extend from a gap between the first and second stator cores 53 and 153 to the other side of the second stator core 153, be sequentially wound around the other side and one side of the second stator core 153 and extend to the gap between the first and second stator 53 and 153, extend from the gap between the first and second stator cores 53 and 153 to the other side of the first stator core 53, and extend along the other side of first stator core 53 to a negative (−) terminal of the power source 90. Accordingly, a current “I” may flow in the “8” shape based on a winding order of the stator coil 92. In this case, the current “I” may flow counterclockwise around the first stator core 53, and the current “I” may flow clockwise around the second stator core 153. Therefore, the first magnetic flux direction M1 generated in the first stator 52 and the second magnetic flux direction M2 generated in second stator 152 may be opposite to each other. Accordingly, a rotation direction Y1 of the first pinion gear 64 and a rotation direction Y2 of the second pinion gear 162 may be opposite to each other, and the ring gear 36 may be rotated in a rotation direction Z1 (e.g., in a clockwise direction of FIG. 4). In addition, the first and second pinion gears 64 and 162 may be rotated at the same speed for a smooth rotation of the ring gear 36. The current “I” flowing around the first stator core 53 may be the same as the current “I” flowing around the second stator core 153. Therefore, a magnitude of the magnetic field generated by the first stator 52 and a magnitude of the magnetic field generated by the second stator 152 may be the same as each other.

Meanwhile, the center support 43 may be provided with a plurality of center support holes 41 which are passages for connecting the stator coil 92 from the first stator core 53 to the second stator core 153.

As shown in FIG. 3, the power transmission device 1 according to an embodiment of the disclosure may further include a cooling device for cooling the drive motor assembly 40. The cooling device of the power transmission device 1 may be connected to an external cooling system (not shown) of the power transmission device 1 to receive oil from the cooling system, and heated oil while cooling the parts in the power transmission device 1 may be discharged to the cooling system. Therefore, oil may be circulated through the external cooling system and the cooling device of the power transmission device 1.

The motor arm 44 of the drive motor assembly 40 may be provided with a supply passage 72 and a discharge passage 74. Oil may be supplied into the drive motor assembly 40 through the supply passage 72, and discharged from the power transmission device 1 through the discharge passage 74. The discharge passage 74 may be connected to a suction motor (not shown), and the suction motor may suck the oil in the drum 10 through the discharge passage 74.

The motor arm 44 may have first and second oil supply holes 76 and 78 formed therein and connected to the supply passage 72. The first oil supply hole 76 may supply oil supplied into the drive motor assembly 40 through the supply passage 72 in the circumferential direction. Oil supplied through the first oil supply hole 76 may cool the first stator 52 and the second stator 152.

The second oil supply hole 78 may supply oil supplied into the drive motor assembly 40 through the supply passage 72 to the front end of the drive motor assembly 40. Oil supplied to the front end of the drive motor assembly 40 may be flowed from the front to the rear along the first and second motor shafts 56 and 156.

A suction pipe 80 may be further disposed on a side of the motor housing 42. The suction pipe 80 may have a free end disposed in the drum 10 to be lower than an oil level OL to suck the oil in the drum 10. An oil filter may be installed in the suction pipe 80 to filter out a foreign material in the sucked oil. In addition, the suction pipe 80 may be connected to the suction motor through the discharge passage 74. Accordingly, when the suction motor is operated, oil in the drum 10 may be sucked through the suction pipe 80, and oil may be discharged to the outside of the power transmission device 1 through the discharge passage 74. The oil may be cooled while passing through the external cooling system, and then supplied back into the power transmission device 1 through the supply passage 72. Meanwhile, a magnet may be attached to the suction pipe 80 to catch iron particles in the oil.

Meanwhile, oil temporarily stored in a lower portion of the drum 10 may be rotated together with the drum 10, introduced between the wheel hub 20 and the drum 10 through the air inlet 6 of the wheel hub 20, and cooled by air passing through the air passage.

FIG. 6 is a cross-sectional view taken along the line B-B of FIG. 2 in a power transmission device according to another embodiment of the disclosure. A power transmission device 1 according to another embodiment of the disclosure is similar to the power transmission device 1 according to an embodiment of the disclosure except for a position of the drive motor assembly 40. Therefore, only the position of the drive motor assembly 40 is described in detail.

As shown in FIGS. 4 and 6, the drive motor assembly 40 according to an embodiment of the disclosure may be disposed on the horizontal line X1, while the drive motor assembly 40 according to another embodiment of the disclosure may be spaced apart from the horizontal line X1 by a first separation distance D1. That is, the center line X3 of each of the first and second motor shafts 56 and 156 may be spaced apart from the horizontal line X1 by the first separation distance D1.

In this way, when the first pinion gear 64 and the second pinion gear 162 are spaced apart from the horizontal line X1, which is a center line of the ring gear 36, a mesh rate of the gears may be increased and the stress may be reduced, thereby increasing a lifespan of the gear 64, 162, or 36.

Although the embodiments of the disclosure have been described hereinabove, the scope of the disclosure is not limited thereto, and all equivalent modifications easily modified by those skilled in the art to which the disclosure pertains are intended to fall within the scope and spirit of the disclosure.

What is claimed is:

1. A power transmission device comprising:
a drive motor assembly including a motor housing, a first motor disposed in a front portion of the motor housing and rotating a first pinion gear in a first rotation direction, and a second motor disposed in a rear portion of the motor housing and rotating a second pinion gear in a second rotation direction opposite to the first rotation direction;
a drum surrounding the drive motor assembly and including a drum disk portion disposed on one surface in a wheel axis direction and a cylindrical portion extending from an outer diameter end of the drum disk portion in the wheel axis direction;
a drum cover coupled to the other surface of the drum in the wheel axis direction, and having a ring gear provided on an outer diameter of the drum cover and meshed with the first and second pinion gears; and
a wheel hub installed with a tire, and coupled to the drum to be rotated together with the drum,
wherein the first and second motors are disposed to be parallel to a horizontal line horizontal to the ground and passing through a center of a wheel.

2. The device of claim 1, wherein
the first and second motors are disposed on the horizontal line.

3. The device of claim 1, wherein
the first and second motors are disposed to be spaced apart from the horizontal line by a first separation distance.

4. The device of claim 1, wherein
the first and second pinion gears are rotated at the same speed.

5. The device of claim 1, wherein
the motor housing further includes a center support protruding radially inward from a middle portion of the motor housing, and
the first motor is disposed at the front of the center support, and the second motor is disposed at the rear of the center support.

6. The device of claim 5, wherein the first motor includes:
a first stator fixed to the front portion of the motor housing and generating a magnetic field;
a first rotor disposed inside the first stator in a radial direction while having a predetermined gap with the first stator, and rotated in the first rotation direction by the magnetic field generated by the first stator; and
a first motor shaft coupled to the first rotor to be rotated together with the first rotor, and extending to the front and the rear in a length direction, and
wherein the first pinion gear is provided at a front end of the first motor shaft that protrudes forward from the motor housing.

7. The device of claim 6, wherein the second motor includes:
a second stator fixed to the rear portion of the motor housing, and generating a magnetic field;
a second rotor disposed inside the second stator in the radial direction while having a predetermined gap with the second stator, and rotated in the second rotation direction by the magnetic field generated by the second stator; and
a second motor shaft coupled to the second rotor to be rotated together with the second rotor, including a motor shaft hole formed in a front center in the length direction, and extending to the rear in the length direction, and
wherein the second pinion gear is provided at a rear end of the second motor shaft that protrudes rearward from the motor housing, and
a rear end portion of the first motor shaft that extends rearward in the length direction is inserted into the motor shaft hole.

8. The device of claim 7, wherein
the first stator is provided by winding a stator coil around a first stator core, the second stator is provided by winding the stator coil around a second stator core, and
the stator coil is wound around the first and second stator cores in an “8” shape such that a current around the first stator core and a current around the second stator core are circulated in opposite directions.
